(19) United States
(12) Patent Application Publication
(10) Pub. No.: US 2012/0011004 A1
(43) Pub. Date: Jan. 12, 2012

(54) Social and shopping network that offers combined use of comparison shopping, classifieds,social networking,consumer and business reviews and news

(75) Inventor: Jacque Ojadidi, Henderson, NV (US)

(73) Assignee: CWEB, INC., Henderson, NV (US)

(21) Appl. No.: 13/018,550

(22) Filed: Feb. 23, 2011

Related U.S. Application Data
(60) Provisional application No. 61/399,207, filed on Jul. 9, 2010.

(51) Int. Cl. G06Q 30/00

(52) U.S. Cl. 705/14.73

(57) ABSTRACT

Securing member logins using PHP in tandem with a MySQL database. Visible registered users login string is embedded within HTML, Different fonts may be used. HTML entry fields are designed to accept a minimum and maximum amount of characters necessary to enter the information into the system. A database also created in MySQL that has fields for a chosen “user name” and chosen” user password and the ability to create a one log in and profile for the registered user to access all the websites at once under the main domain and or other sites within the network as a first login.

The Network has and uses all features combined. If you are on the shopping network you can post classifieds, search classifieds, post business reviews sell or buy products on the shopping network when logged in one account and perform all tasks at the same time. For example, you can be on the social website, business reviews shopping, price comparison, posting business reviews, adding video posting or classified ads online or any other site within the network at the same time using all the products offered on the website combined without going to another website with the option to use one login password account in the CWEB® network.

We are claiming the benefit of the application prior status non provisional filing Application No. 61/399,207 file Jul. 9, 2010

Social and Shopping network that offers combined use of comparison shopping, classifieds, social networking, consumer and business reviews and news.

The Network has and uses all features combined. If you are on the shopping network you can post classifieds or search classifieds or sell product on the shopping network when logged in one account and perform all tasks at the same time. You can write business reviews, post classifieds, sell on the shopping network.

You be on the social website and at the same time using all the products offered on the website combined on the social network without going to another website.

The Network has and uses all features combined. If you are on the shopping network you can post classifieds, search classifieds, post business reviews sell product on the shopping network when logged in one account and perform all tasks at the same time.

You can be on the social website and at the same time using all the products offered on the website combined on the social network without going to another website and having the option to use one login password account using shopping, price comparison, posting business reviews, posting classified ads online in the CWEB® network.

1. The Network has and uses all features combined. If you are on the shopping network you can post classifieds or search classifieds or sell product on the shopping network when logged in one account and perform all tasks at the same time. You can write business reviews, post classifieds, sell on the shopping network. You be on the social website and at the same time using all the products offered on the website combined on the social network without going to another website. The Network has and uses all features combined. If you are on the shopping network you can post classifieds, search classifieds, post business reviews, sell product on the shopping network when logged in one account and perform all tasks at the same time. You can be on the social website and at the same time using all the products offered on the website combined on the social network without going to another website and having the option to use one login password account using shopping, price comparison, posting business reviews, posting classified ads online in the CWEB® network.
